(19) United States
(12) Patent Application Publication
(10) Pub. No.: US 2007/0074224 A1
(43) Pub. Date: Mar. 29, 2007

(54) Kernel based profiling systems and methods

(75) Inventor: Cheng-Che Chen, Kaohsiung City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Inc.

(21) Appl. No.: 11/237,492

(22) Filed: Sep. 28, 2005

(51) Int. Cl. G06F 9/46

(52) U.S. Cl. 718/108

(57) ABSTRACT

Profiling systems and methods. A profiling system comprises a processor that runs a kernel including a scheduler. The scheduler locates a context that to be switched to, records a time and an identification of the context, and switches to the context for execution. The context comprises a thread, a process, or an interrupt service routine. The recorded time and the identification of the context are used for context profiling.

### BACKGROUND

The present disclosure relates generally to data processing, and more particularly to the profiling of contexts run on kernel based systems.

Profiling comprises analyzing performance, computing resource utilization, or execution of contexts comprising threads, processes and ISRs (Interrupt Service Routines) on data processing systems. Several statistical techniques have been developed for monitoring performance of programs. One technique is to monitor the time spent executing respective functions of a program. Bolosky (U.S. Pat. No. 5,485,574) discloses a technique that counts the instructions executed by a processor, and counts the number of times that a section of code has been called during execution of a program.

Generally, data processing systems are kernel based. A kernel of the data processing system can provide an interrupt service, in which, when a processor triggers an interrupt, a specific ISR is branched to according to the interrupt source, and executed to service the interrupt. The kernel of the data processing system is multi-tasking, that is, multiple tasks are simultaneously executed thereon. A scheduler of the kernel controls the order of context for execution, and performs a context switch procedure correspondingly. The contexts comprise threads, processes, and ISRs. In the procedure, a next context to be switched to is first located, and then is switched to. The context switch involves saving the context of the running task and restoring the previously-saved context.

These function and instruction based techniques cannot satisfy the need of performance analysis for task precision. If the resource required for executing a thread needs to be monitored, additional instructions are added to a thread, such that signals at high level are output via an IO pin, and additional instructions are added to an ISR, such that signals at low level are output via an IO pin. Since an IO pin can be used to monitor a thread or ISR, a large number of available IO pins is required if several thread and ISR are to be monitored, simultaneously. IO pins, however, are limited in data processing systems. Additionally, an additional logic analyzer is required to observe and calculate the signals. The profiling procedure is inconvenient and time-consuming. Another conventional technique monitors the active context of the system at every time interval, and analyzes performance, computing resource utilization, or execution of context accordingly. In this technique, while no instruction is needed to add to the thread and ISR, accuracy is compromised.

### SUMMARY

Profiling systems and methods are provided.

An embodiment of a profiling system comprises a processor that runs a kernel including a scheduler. The scheduler locates a context that to be switched to, records a time and an identification of the context, and switches to the context for execution. The recorded time and the identification of the context are used for context profiling.

An embodiment of a profiling system comprises a processor that runs a kernel including an ISR dispatcher. The ISR dispatcher locates an interrupt source, records a time and an identification of the interrupt source, and branches to an ISR corresponding to the interrupt source for execution. The time and the identification of the interrupt source are recorded before branching to the ISR and/or after branching to the ISR.

An embodiment of a profiling system comprises a processor that runs a kernel including an ISR. The ISR records a time and an identification of an interrupt, and services the interrupt. The time and the identification of the interrupt are recorded before servicing the interrupt and/or after servicing the interrupt.

Profiling systems and methods may take the form of program code embodied in a tangible media. When the program code is loaded into and executed by a machine, the machine becomes an apparatus for practicing the disclosed method.

### DESCRIPTION OF THE DRAWINGS

The invention will become more fully understood by referring to the following detailed description with reference to the accompanying drawings, wherein:

FIG. 1 is a schematic diagram illustrating an embodiment of a profiling system;

FIG. 2 is a flowchart of an embodiment of a profiling method for a scheduler;

FIG. 3 is a flowchart of an embodiment of a profiling method for an ISR dispatcher;

FIG. 4 is a flowchart of another embodiment of a profiling method for an ISR dispatcher;

FIG. 5 is a flowchart of an embodiment of a profiling method for an ISR;

FIG. 6 is a flowchart of another embodiment of a profiling method for an ISR; and

FIG. 7 shows an example of timing sequence analysis.

### DESCRIPTION

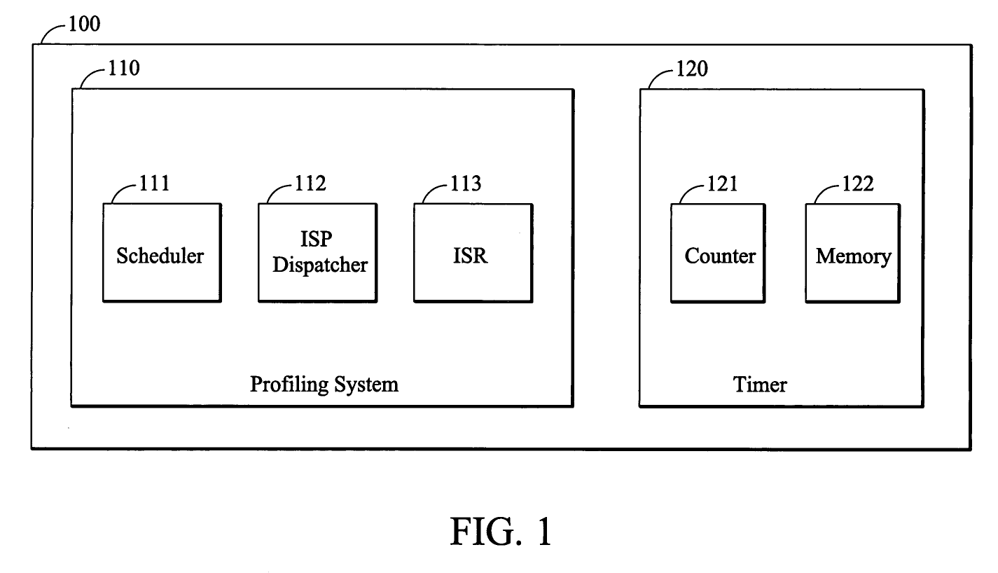

Profiling systems and methods are provided. FIG. 1 is a schematic diagram illustrating an embodiment of a profiling system. The profiling system 100 may be a data processing system comprising a processor (not shown) that runs a kernel 110. In some embodiments, the data processing system may be an embedded system, such as a mobile station.

In the embodiment, the kernel 110 can simultaneously handle multiple threads (contexts) by time-sharing one processor. To control the execution order of threads, the kernel 110 comprises a scheduler 111 for scheduling the context switch procedure. The context switch procedure is performed while kernel 110 instructs to switch to other contexts. The contexts may be threads, processes, tasks or ISRs. It is understood that the threads mentioned above may be normal threads or interrupt threads having highest priority for interrupt service in real time. Additionally, the profiling system 100 comprises a timer 120 which may be a 3G (third generation) timer or a TDMA (Time Division Multiple Access) timer. It is understood that the timer 120 is not limited thereto, and any kind of timer is applicable. While performing the context switch procedure by the scheduler 111, in the present invention, additional information of contexts is recorded in a memory (not shown) which could be disposed in the kernel 110 or the scheduler 111. The recorded additional information is used to monitor the context switching timing for further context profiling. For example, the information can be used to analyze the load distribution of the system (time spent on respective threads) computing resources used for respective threads, and active threads at any time. Detail description of the profiling and analyzing method of the present invention will be further illustrated as follows.

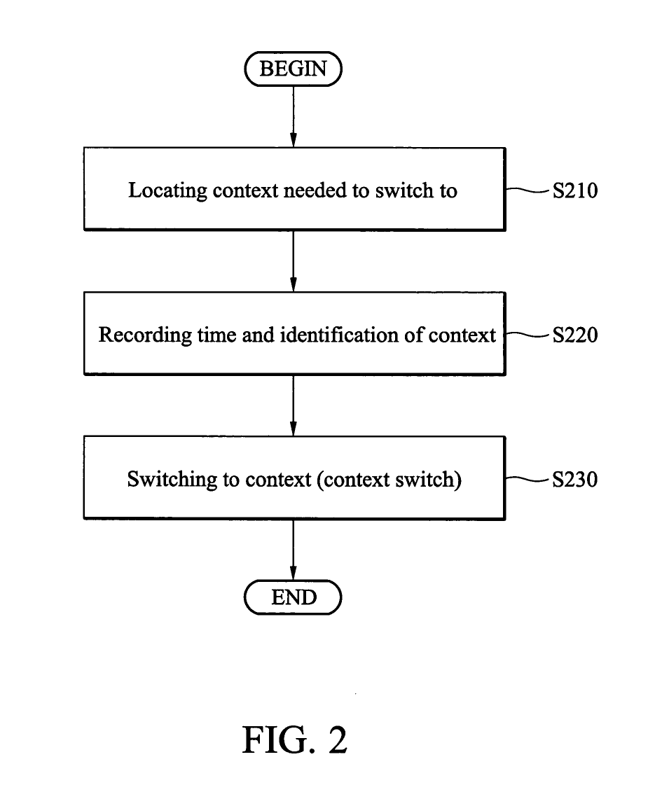

FIG. 2 is a flowchart of an embodiment of a profiling method for a scheduler 111. During context switching, in step S210, the scheduler 111 first locates a next context to be switched to. In step S220, a switching time and an identification of the next context are recorded. After the switching time and the identification of the next context are recorded, in step S230, the scheduler 111 then switches to the next context for further execution. The recorded switching time information may be generated by the timer 120. It should be noted that the information of the switching time and the identification of the next context for context profiling can be directly written to memory (not shown) of the system 100, or transmitted to a device via transmission media for further analysis.

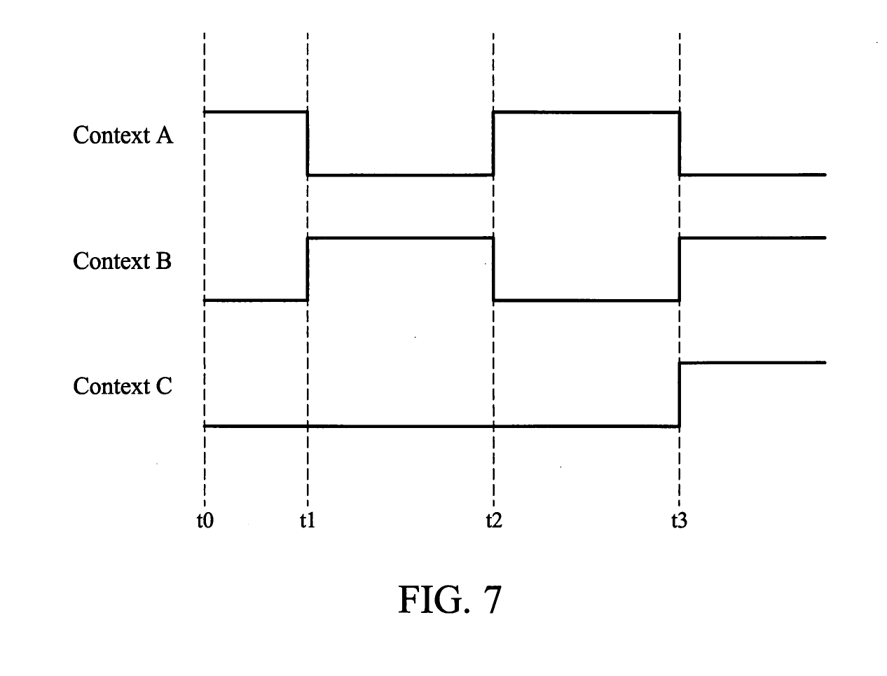

After profiling, according to the recorded information, a timing sequence analysis chart can be obtained as shown in FIG. 7. It should be understood that using the timing sequence analysis chart is only an example of analyzing contexts. Other alternative ways to analyze contexts according the recorded information should be covered in the present invention. As shown in FIG. 7, three contexts, A, B, C, are provided. The context A is executed within t0˜t1 and t2˜t3, context B is executed within t1˜t2, and context B and C are both executed after t3. The recorded information of those contexts comprise (t0,A), (t1,B), (t2,A), (t3,B) and (t3,C). By calculating the time differences of the recorded information, the present invention can analyze the usage of each context.

For example, as shown in FIG. 7, it is assumed that t0 is 5 second, t1 is 10 second, t2 is 20 second, and t3 is 30 second, the context A is active between t0 to t1 and between t2 to t3. To analyze the CPU usage for context A between time period 8 to 26 seconds, it is found that, the context A is active between time 8-10 seconds and time 20-26-seconds, totally 8 ((10−8)+(26−20)) second usage period. Thus, the CPU usage for context A can be determined according to the usage time radio in the time period 8 to 26 seconds. In this example, the usage time radio could be 8/(26−8)=44%.

In some embodiments, the timer 120 may be a high frequency timer. Preferably, the frequency of the timer must exceed the switching frequency of contexts. In this embodiment, the timer 120 may be constituted by a counter 121 and a memory 122 storing a predetermined wrap value and a preset value. The counter 121 counts incrementally. When the value of the counter 121 reaches the wrap value, the counter 121 will be reset to 0. If the value of the counter 121 reaches the preset value, an interrupt is triggered. Here, to avoid errors resulting from the reset operations when hitting the wrap value, the preset value should be less than the wrap value. For example, as to a 3G timer, the counter 121 is of a specific frequency 3.84 MHz or a multiple thereof. As to the TDMA timer, the specific frequency may be 13/12 MHz or a multiple thereof and the wrap value may be 4999. It is understood that the wrap value can be fixed or configurable. The wrap value can be adjusted to equal to or exceed 4999 according to a network status connected by the system.

Furthermore, as shown in FIG. 1, the profiling system 100 may further comprise an ISP dispatcher 112 and at least one ISP 113. In the system 100, when an interrupt occurs, the ISR dispatcher 112 intercepts the interrupt and runs the required ISR 113 for interrupt operation according to the interrupt number. In the present invention, similar to the scheduler 111, additional information may be recorded in the memory when the ISR dispatcher 112 and ISR 113 perform interrupt operation as an interrupt occurs. The recorded additional information is used to monitor the interrupting timing of respective threads and ISRs for context profiling. For example, the information can be used to analyze the load distribution of the system (time spent on respective threads ad ISRs), operating resources used for respective threads and ISRs, and active threads and ISRs at any time.

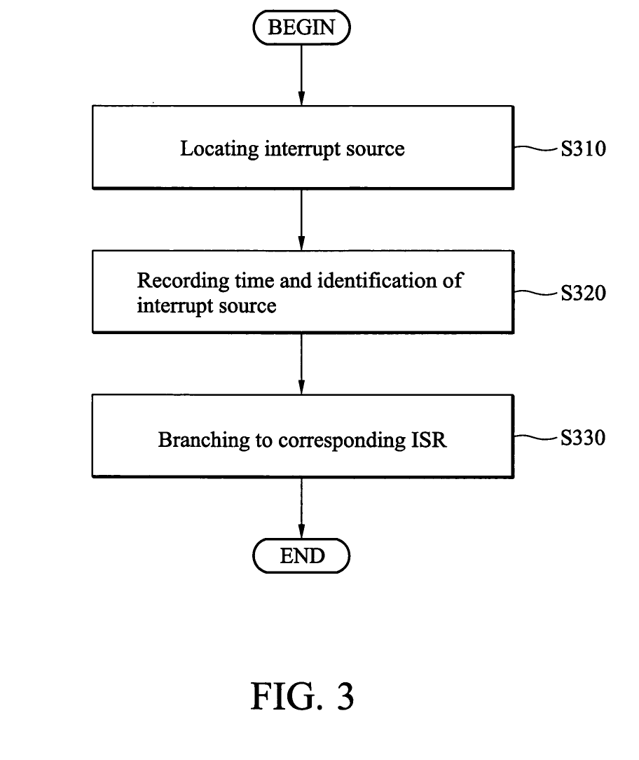

FIG. 3 is a flowchart of an embodiment of a profiling method for an ISR dispatcher 112. In step S310, the ISR dispatcher 112 locates an interrupt source. It is understood that if an interrupt occurs, the ISR dispatcher 112 can intercept the interrupt. In step S320, an interrupt time and an identification of the interrupt source are recorded. After the interrupt time and the identification of the interrupt source are recorded, in step S330, the ISR dispatcher 112 then branches to an ISR 113 corresponding to the interrupt source for further execution. Similarly, in some embodiments, the interrupt time is generated by the timer 120, according to the value of the counter 121 and the wrap value. It is understood that the corresponding ISR of the interrupt source is predefined, and located according to the interrupt number.

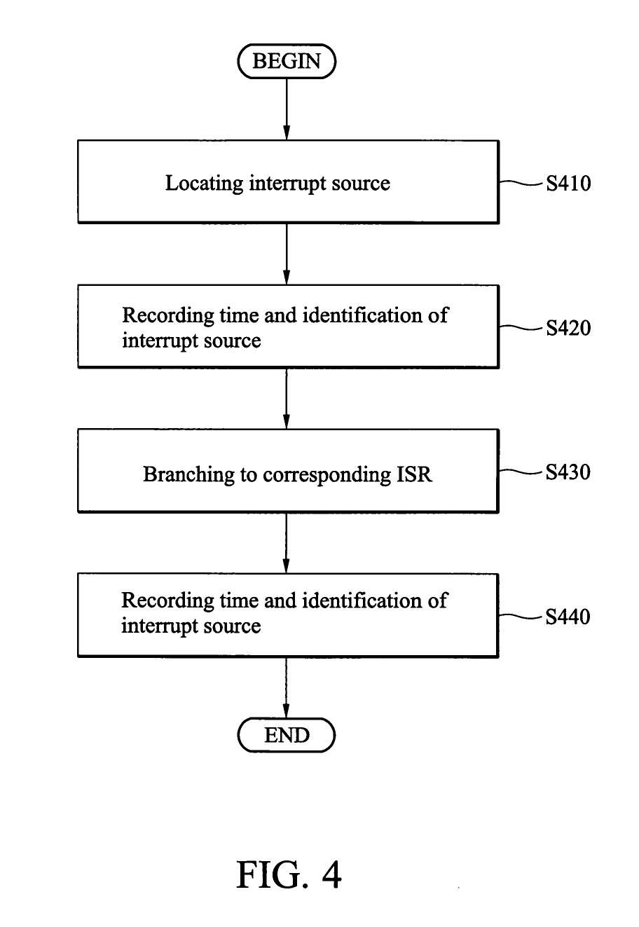

FIG. 4 is a flowchart of another embodiment of a profiling method for an ISR dispatcher 112. In step S410, ISR dispatcher 112 locates an interrupt source. In step S420, an interrupt time and an identification of the interrupt source are recorded. After the interrupt time and the identification of the interrupt source are recorded, in step S430, an ISR 113 corresponding to the interrupt source is branched to for execution. After the ISR 113 is completed, in step S440, the interrupt complete time and the identification of the interrupt source will be recorded.

In some embodiments, the kernel 110 will always perform a context switch procedure after handling an interrupt. In this case, the ISR dispatcher 112 only requires recording the interrupt time, with no need to further record the interrupt complete time, as described in FIG. 3, since the scheduler 111 will then record the switching time during the context switch procedure. However, for some kernels that do not always perform a context switch procedure after handling an interrupt, it is necessary for the ISR dispatcher 112 to further record an interrupt complete time, as described in FIG. 4.

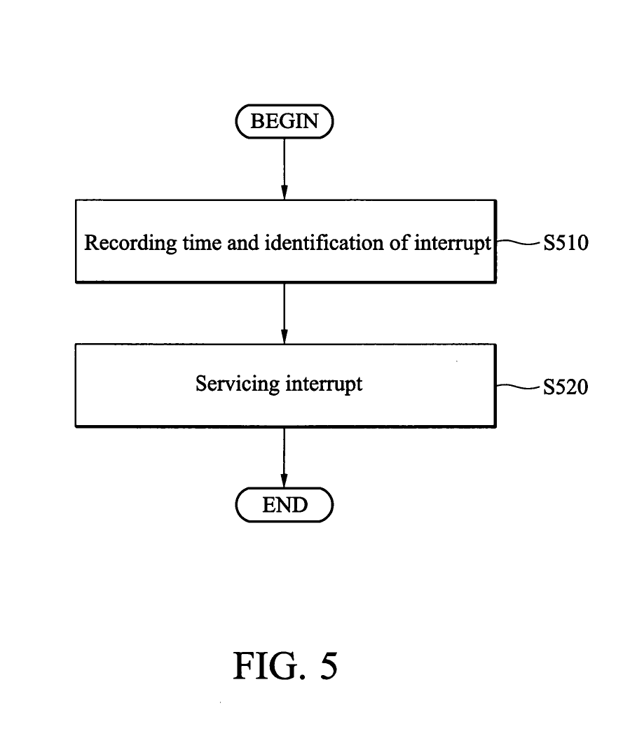

FIG. 5 is a flowchart of an embodiment of a profiling method for an ISR. In step S510, an interrupt time and an identification of an interrupt are recorded. Similarly, in some embodiments, the value of the counter 121 and the wrap value 122 are recorded first, and the time is generated accordingly. After the interrupt time and the identification of the interrupt are recorded, in step S520, the interrupt is serviced.

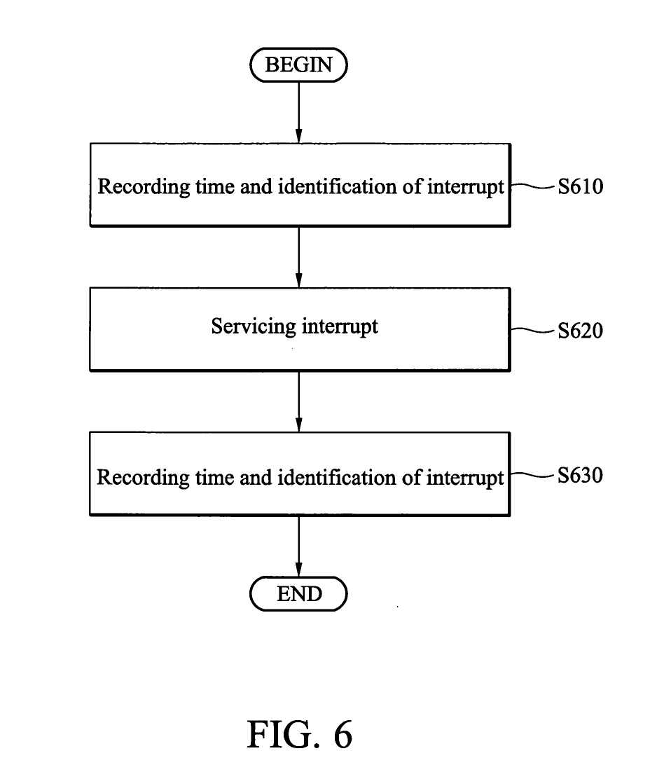

FIG. 6 is a flowchart of another embodiment of a profiling method for an ISR 113. In step S610, an interrupt time and an identification of an interrupt are recorded. After the time and the identification of the interrupt are recorded, in step S620, the interrupt is serviced. After the interrupt is serviced, in step S630, a complete interrupt time and the identification of the interrupt are recorded.

Similarly, some kernels always perform a context switch procedure after servicing an interrupt. In this case, the ISR only needs to record the interrupt time, as shown in FIG. 5, since scheduler 111 will then record the switching time during the context switch procedure. However, for some kernels that do not always perform a context switch procedure after servicing an interrupt, it is necessary for the ISR to further record an interrupt complete time, as shown in FIG. 6.

In the invention, the scheduler, ISR dispatcher, and ISR additionally record the time and identification of a context to be executed. Based on this recorded data, the timing sequence of respective contexts, CPU usage for respective contexts in a specific period, and CPU loading can be analyzed.

Profiling systems and methods, or certain aspects or portions thereof, may take the form of program code (i.e., executable instructions) embodied in tangible media, such as products, floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those skilled in this technology can still make various alterations and modifications without departing from the scope and spirit of this invention. Therefore, the scope of the present invention shall be defined and protected by the following claims and their equivalents.

What is claimed is:

1. A profiling system comprising a processor that runs a kernel, comprising a scheduler locating a context to be switched to, recording a time and an identification of the context, and switching to the context for execution.

2. The system of claim 1 wherein the context comprises a thread, a process, or an interrupt service routine.

3. The system of claim 1 further comprising a timer comprising a counter and a wrap value, in which the counter increases at a specific frequency, and resets if the value of the counter reaches the wrap value.

4. The system of claim 3 wherein the wrap value is adjusted according to a network status connected by the system.

5. The system of claim 3 wherein the wrap value is fixed.

6. The system of claim 3 wherein the timer comprises a TDMA (Time Division Multiple Access) timer.

7. The system of claim 3 wherein the timer comprises a 3G (third generation) timer.

8. The system of claim 3 wherein the scheduler records the time by recording the value of the counter and the wrap value, and generating the time accordingly.

9. The system of claim 3 wherein the timer further comprises a preset value, and triggers an interrupt if the value of the counter reaches the preset value.

10. A profiling method for use in a data processing system comprising a processor that runs a kernel, the method comprising:
locating a context to be switched to;
recording a time and an identification of the context; and
switching to the context for execution.

11. The method of claim 10 wherein the context comprises a thread, a process, or an interrupt service routine.

12. The method of claim 10 further comprising providing a timer comprising a counter and a wrap value, in which the counter increases at a specific frequency, and resets if the value of the counter reaches the wrap value.

13. The method of claim 12 further comprising adjusting the wrap value according to a network status connected by the system.

14. The method of claim 12 wherein the wrap value is fixed.

15. The method of claim 12 wherein the timer comprises a TDMA (Time Division Multiple Access) timer.

16. The method of claim 12 wherein the timer comprises a 3G (third generation) timer.

17. The method of claim 12 further comprising recording the value of the counter and the wrap value, and generating the time accordingly.

18. The method of claim 12 further comprising triggering an interrupt if the value of the counter reaches a preset value.

19. A profiling system comprising a processor that runs a kernel, comprising:
an ISR (Interrupt Service Routine) dispatcher locating an interrupt source, recording a time and an identification of the interrupt source, and branching to an ISR corresponding to the interrupt source for execution,
wherein the time and the identification of the interrupt source are recorded before branching to the ISR.

20. A profiling method for use in a data processing system comprising a processor that runs a kernel, the method comprising:
locating an interrupt source;
recording a time and an identification of the interrupt source; and
branching to an ISR corresponding to the interrupt source for execution,
wherein the time and the identification of the interrupt source are recorded before branching to the ISR.

21. A profiling system comprising a processor that runs a kernel, comprising:
an ISR (Interrupt Service Routine) recording a time and an identification of an interrupt, and servicing the interrupt,
wherein the time and the identification of the interrupt are recorded before servicing the interrupt.

22. A profiling method for use in a data processing system comprising a processor that runs a kernel, the method comprising:
recording a time and an identification of an interrupt; and
servicing the interrupt,
wherein the time and the identification of the interrupt are recorded before servicing the interrupt.
